(19) United States
(12) Patent Application Publication
(10) Pub. No.: US 2008/0231819 A1
(43) Pub. Date: Sep. 25, 2008

(54) Method of Displaying an Image for a Document Projector

(75) Inventors: Yung-Che Chang, Chung Ho City (TW); Chih-Ming Chen, Chung Ho City (TW); Lien-Kai Chou, Chung Ho City (TW); Yung-Hsi Wu, Chung Ho City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: AVERMEDIA TECHNOLOGIES, INC., Chung Ho City (TW)

(21) Appl. No.: 11/870,539

(22) Filed: Oct. 11, 2007

(30) Foreign Application Priority Data
Mar. 23, 2007 (TW) 96110242

(51) Int. Cl. G03B 21/26

(52) U.S. Cl. 353/121

(57) ABSTRACT

A method of displaying an image for a document projector is disclosed. The method includes capturing the image of an object to get an input image; generating a frame; overlapping the frame and the input image, wherein the frame separates the input image into an emphasized area and a not-emphasized area to form an output image; and displaying the output image.

### RELATED APPLICATIONS

This application claims priority to Taiwan Application Serial Number 96110242, filed Mar. 23, 2007, which is herein incorporated by reference.

### BACKGROUND

1. Field of Invention

The present invention relates to a document projector. More particularly, the present invention relates to a method of displaying an image for a document projector.

2. Description of Related Art

Projectors have been applied in many fields to provide different functions, such as projecting enlarged images at conferences, or projecting and displaying instant images on a projecting screen in a presentation, or displaying instant images at a teaching brief.

A document projector is a convenient tool for projecting. The document projector could instantly project an image of an object on the screen and does not need to make an image or a document file. The object placed on the shooting zone of a projector camera may be captured and projected on the screen instantly in the document projector. Thus, the document projector is a convenient teaching aid for providing instant situation of the object.

One way to focus audience's attention during the presentation is to use a laser pen. Another way to focus audience's attention is to cover the unnecessary area of the object by hands or paper. However, the above ways may increase the movements of an operator during the presentation.

For the foregoing reasons, there is a need for focusing audience's attention during presentation with the document projector.

### SUMMARY

The embodiments of the invention provide a method of displaying an image for a document projector. The method includes capturing an object to get an input image; generating a frame; overlapping the frame and the input image, wherein the frame separates the input image into an emphasized area and a not-emphasized area to form an output image; and displaying the output image.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1A to FIG. 1D is an implementation drawing of different states of an embodiment of this invention;

FIG. 2A to FIG. 2B is an implementation drawing of different states of another embodiment of this invention;

FIG. 3 is an implementation block diagram of another embodiment of this invention; and

FIG. 4 is a flowchart diagram of another embodiment of this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The document projector is a common presentation tool. How to focus the audience's attention during presentation has become an important function of the document projector, especially when the document projector is utilized as a teaching aid. The embodiments of the invention provide a method for displaying an image from a document projector to mark an emphasized area of the object image to focus audience's attention during the presentation.

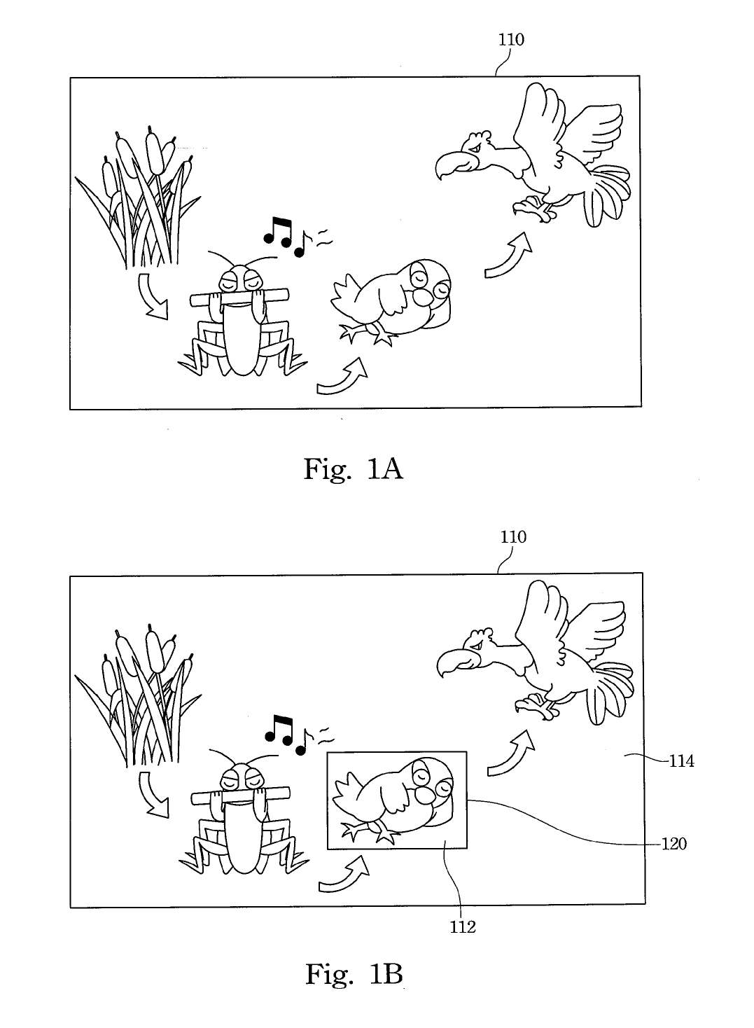

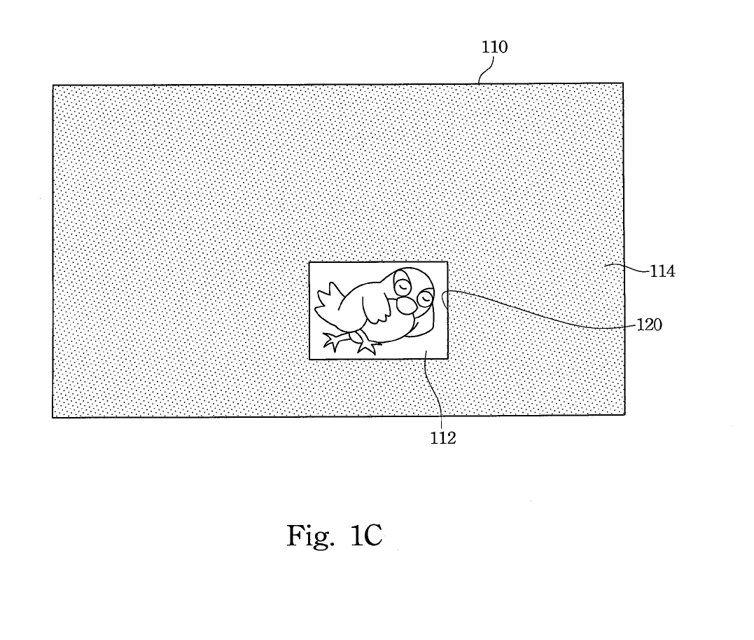

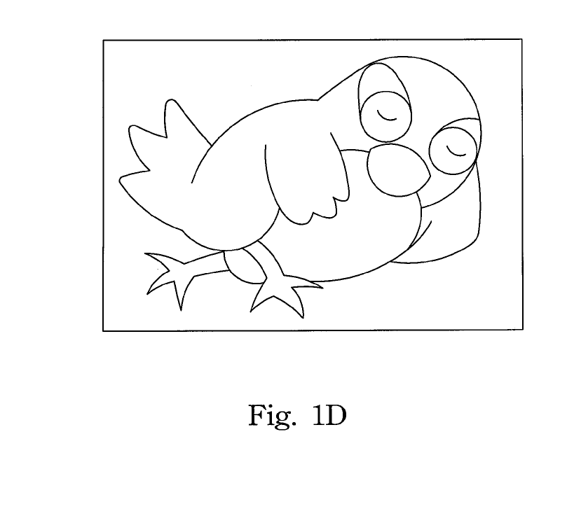

Refer to FIG. 1A to FIG. 1D. FIG. 1A to FIG. 1D illustrate an implementation drawing of different states of an embodiment of a method of displaying an image for a document projector of this invention. A document projector may use a camera to capture the image of an object to receive an object image 110 as an input image, as shown in FIG. 1A. Then, the method of displaying an image for a document projector includes generating a frame 120 overlapped on the input image 110. The frame 120 separates the object image 110 into an emphasized area 112 and a not-emphasized area 114 to form an output image of the object. The emphasized area 112 is located in the frame 120 and the not-emphasized area 114 is located out of the frame 120 in this embodiment. The output object image 110 is shown in FIG. 1B.

In this embodiment, the method of displaying an image for a document projector may further include covering the not-emphasized area 114 of the object image 110 to highlight the emphasized area 112 of the object image 110 to focus the audience's attention. As the output object image shown in FIG. 1C, covering the not-emphasized area 114 may be to blacken the not-emphasized area 114 so as to not display the not emphasized area 114. Covering the not-emphasized area 114 may also be fogging the not-emphasized area 114 of the object image 110 to form a translucent not-emphasized area 114 for highlighting the emphasized area 112. The emphasized area 114 may be enlarged to a full screen mode rapidly, as shown in FIG. 1D.

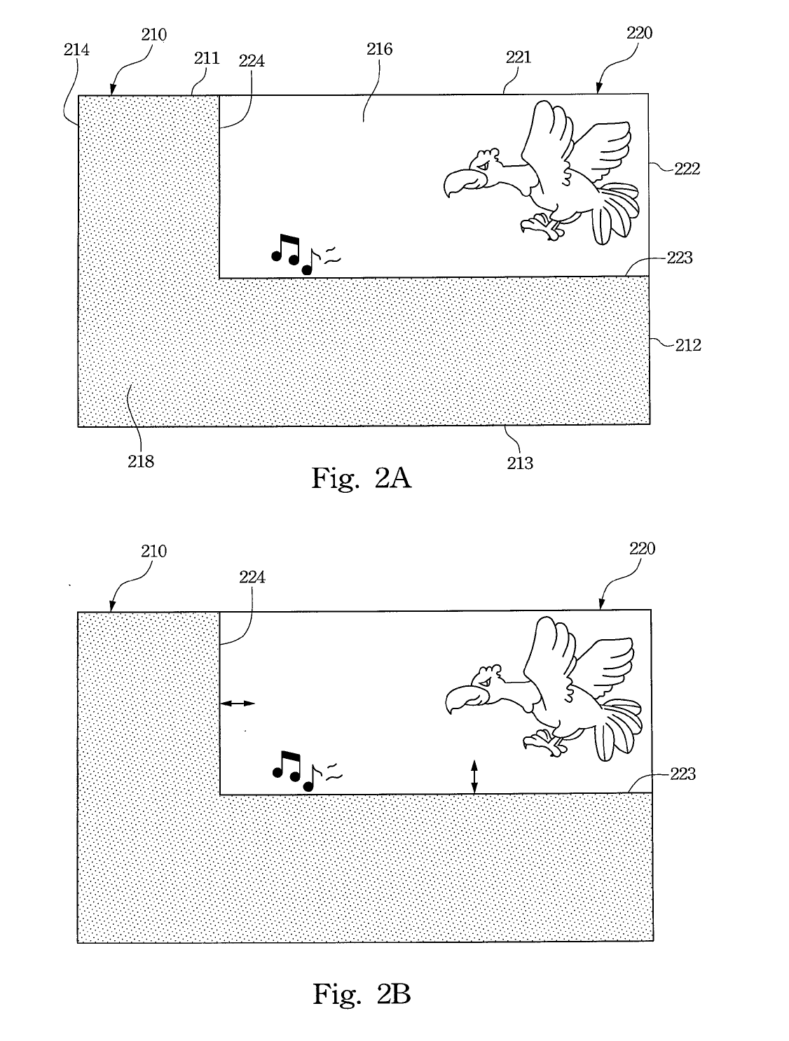

Refer to FIG. 2A to FIG. 2B. FIG. 2A to FIG. 2B illustrate an implementation drawing of different states of another embodiment of the method of displaying an image for a document projector of this invention. The frame may be a rectangle frame 220 in this embodiment. The rectangle frame 220 has four sides 221-222-223-224. The input object image 210 has four sides 211-212-213-214. Two adjacent sides 221 and 222 of the rectangle frame 220 are fixed on two adjacent sides 211 and 212 of the input object image 210. The emphasized area 216 is located in the rectangle frame 220 and the not-emphasized area 218 is located out of the rectangle frame 220 in this embodiment.

The not-emphasized area 218 of the object image 210 may be covered as shown in FIG. 2A. In FIG. 2B, two other adjacent sides 223 and 224 of the rectangle frame 220 may be rolled vertically or horizontally to display different ranges of the object image 210. Covering the not-emphasized area 218 of the object image 210 may include blackening the not-emphasized area 218 or fogging the not-emphasized area 218.

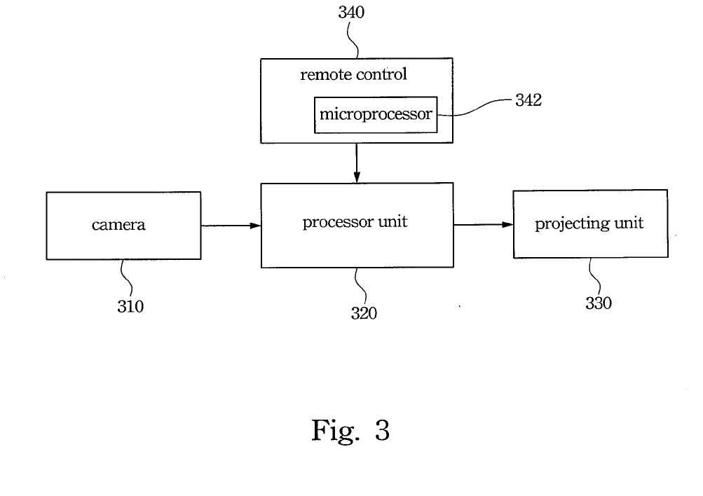

Refer to FIG. 3. FIG. 3 illustrates an implementation block diagram of another embodiment of this invention. The document projector includes a camera 310, a processor unit 320, a projecting unit 330, and a remote control 340. The camera 310 may shoot the object to capture the input object image. The remote control 340 may be a controller with a plurality of button to operate the document projector. The remote control 340 can generate the frame and choose a color, a dimension, a shape, or a coordinate of the frame. The remote control 340 has a microprocessor 342 to calculate the coordinate and the size of the frame. The object image shot by the camera 310 may be regarded as the input image and sent to the processor unit 320. A signal of the frame of the remote control 340 may be wirelessly transmitted to the processor unit 320. The processor unit 320 may overlap the frame and the input image, and the frame would separate the input image into the emphasized area and the not-emphasized area to form the output image as shown in FIG. 1B. The output image could be transmitted to the projecting unit 330 and projected to the screen, or the output image could be displayed on a monitor.

The processor unit 320 may be programmed to blacken or fog the not-emphasized area. The processor unit 320 may also be programmed to enlarge the emphasized area in the frame to the full screen mode by pressing the buttons of the remote control 340. The camera 310 may be a charge coupled device (CCD). The processor unit 320 and the microprocessor 342 may be a programmable logic device (PLD), a field programmable gate array (FPGA), a complex programmable logic device (CPLD), or an integrated circuit chip (IC chip).

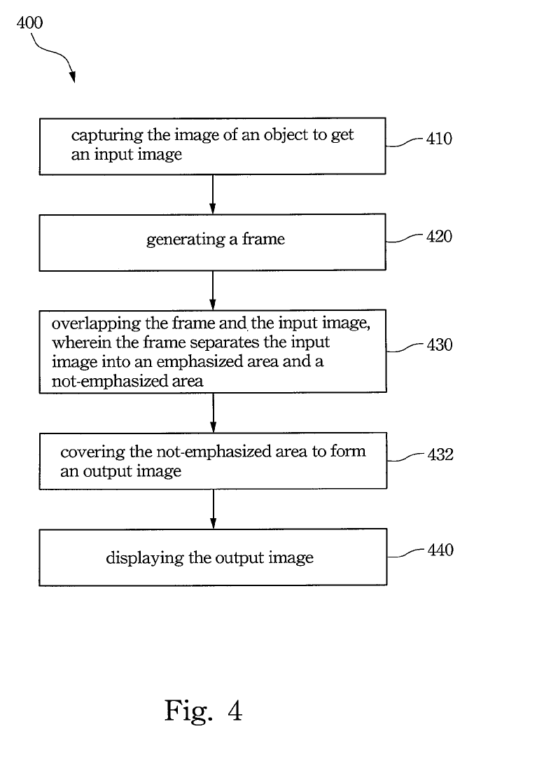

Refer to FIG. 4. FIG. 4 illustrates a flowchart diagram of another embodiment of the method of displaying an image for a document projector of this invention. The method 400 of displaying an image for a document projector starts at Step 410. In Step 410 an image of the object is captured to get the input image. Then, in Step 420 the frame is generated and in Step 430 the frame and input image are overlapped. The frame may separate the input image into the emphasized area and the not-emphasized area to form the output image. Then, in Step 440 the output image is displayed. The output image may be displayed in Step 440 by projecting the output image on the screen or displaying the output image on the monitor. The method 400 would further include Step 432 for covering the not-emphasized area.

The method of displaying an image for a document projector could generate a frame on the object image. The frame would separate the object image into an emphasized area and a not-emphasized area. Moreover, the not-emphasized area of the object image could be covered to highlight the emphasized area.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method of displaying an image for a document projector comprising:
capturing the image of an object to get an input image;
generating a frame;
overlapping the frame and the input image, wherein the frame separates the input image into an emphasized area and a not-emphasized area to form an output image; and
displaying the output image.

2. The method of claim 1, wherein generating the frame comprises selecting a color, a dimension, a shape, or a coordinate of the frame.

3. The method of claim 2, wherein selecting the color, the dimension, the shape, or the coordinate of the frame is operating a remote control of the document projector.

4. The method of claim 1, wherein the emphasized area is located in the frame, the not-emphasized area is located out of the frame.

5. The method of claim 4, further comprising covering the not-emphasized area to form the output image.

6. The method of claim 4, further comprising enlarging the emphasized area to a full screen mode.

7. The method of claim 4, wherein covering the not-emphasized area is to blacken the not-emphasized area so that the not-emphasized area is not displayed.

8. The method of claim 4, wherein covering the not-emphasized area is to fog the not-emphasized area so that a translucent not-emphasized area is generated.

9. The method of claim 1, wherein the frame is a rectangle frame.

10. The method of claim 9, wherein two adjacent sides of the frame are fixed on two adjacent sides of the input image.

11. The method of claim 10, further comprising rolling other two adjacent sides of the rectangle frame vertically or horizontally.

12. The method of claim 9, wherein the emphasized area is located in the rectangle frame, the not-emphasized area is located out of the rectangle frame.

13. The method of claim 12, further comprising covering the not-emphasized area to form the output image.
